(19) United States
(12) Patent Application Publication
(10) Pub. No.: US 2017/0286420 A1
(43) Pub. Date: Oct. 5, 2017

(54) PATTERN MATCHING CIRCUIT

(71) Applicant: Intel Corporation, Santa Clara, CA (US)

(72) Inventors: Amit Agarwal, Hillsboro, OR (US); Steven K. Hsu, Lake Oswego, OR (US); Kaushik Vaidyanathan, Santa Clara, CA (US); Ram K. Krishnamurthy, Portland, OR (US)

(21) Appl. No.: 15/085,816

(22) Filed: Mar. 30, 2016

(51) Int. Cl. G06F 17/30; G06F 21/56

(52) U.S. Cl. CPC G06F 17/3033; G06F 17/30324; G06F 17/30477; G06F 21/564; G06F 2221/034

(57) ABSTRACT

Embodiments include a pattern matching circuit that implements a Bloom filter including one or more hash functions. The hash functions may generate respective addresses corresponding to bits of a memory array. Various techniques for improving the area and/or power efficiency of the pattern matching circuit are disclosed. For example, a number of logic 1 bits per column of hash matrixes associated with the one or more hash functions may be restricted to a pre-defined number. A plurality of addresses generated by the hash functions may use the same column address to correspond to bits of a same column. A single read port memory may be used to simultaneously read two bits and generate an output signal that indicates whether the two bits are both a first logic value. Other embodiments may be described and claimed.

### STATEMENT OF GOVERNMENT INTEREST

This invention was made with U.S. Government support under contract number FA8650-13-3-7338-0128. The U.S. Government has certain rights in this invention.

### FIELD

Embodiments of the present invention relate generally to the technical field of electronic circuits, and more particularly to pattern matching circuits.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Pattern matching in computing devices is used for several applications, such as web caching, address lookup, network measurement, intrusion and anomaly detection, and deep packet inspection. The pattern matching circuit used is a key driver of power and performance.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates a pattern matching system 100 in accordance with various embodiments.

FIG. 2 illustrates an anchored regular expression in accordance with various embodiments.

FIG. 3 illustrates a filtering technique that may be performed by a pattern matching filter, in accordance with various embodiments.

FIG. 4 illustrates a technique for generating and using a pattern set table in conjunction with the filtering technique of FIG. 3, in accordance with various embodiments.

FIG. 5 is a graph to illustrate plots of the probability of a positive match being true or false compared with the number of hash functions used for different sizes of bloom filters, in accordance with various embodiments.

FIG. 6 illustrates an H3 matrix and corresponding hash function, in accordance with various embodiments.

FIG. 7 shows simulation results for the false positive probability, Chi-squared test, reduction in number of gates, and number of gate stages for a pattern matching circuit that uses an H3 matrix with different numbers of logic 1 bits per column, in accordance with various embodiments.

FIG. 8 illustrates a read port 800 in accordance with various embodiments.

FIG. 9 illustrates a pattern matching filter circuit in accordance with various embodiments.

FIG. 10 illustrates an example system configured to employ the apparatuses and methods described herein, in accordance with various embodiments.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

Embodiments include a pattern matching circuit that implements a Bloom filter including one or more hash functions. The hash functions may generate respective addresses corresponding to bits of a memory array. Various techniques for improving the area and/or power efficiency of the pattern matching circuit are disclosed. For example, a number of logic 1 bits per column of hash matrixes associated with the one or more hash functions may be restricted to a pre-defined number. Additionally, or alternatively, a plurality of addresses generated by the hash functions may use the same column address to correspond to bits of a same column. A single read port memory may be used to simultaneously read two bits and generate an output signal that indicates whether the two bits are both a first logic value (e.g., logic 1).

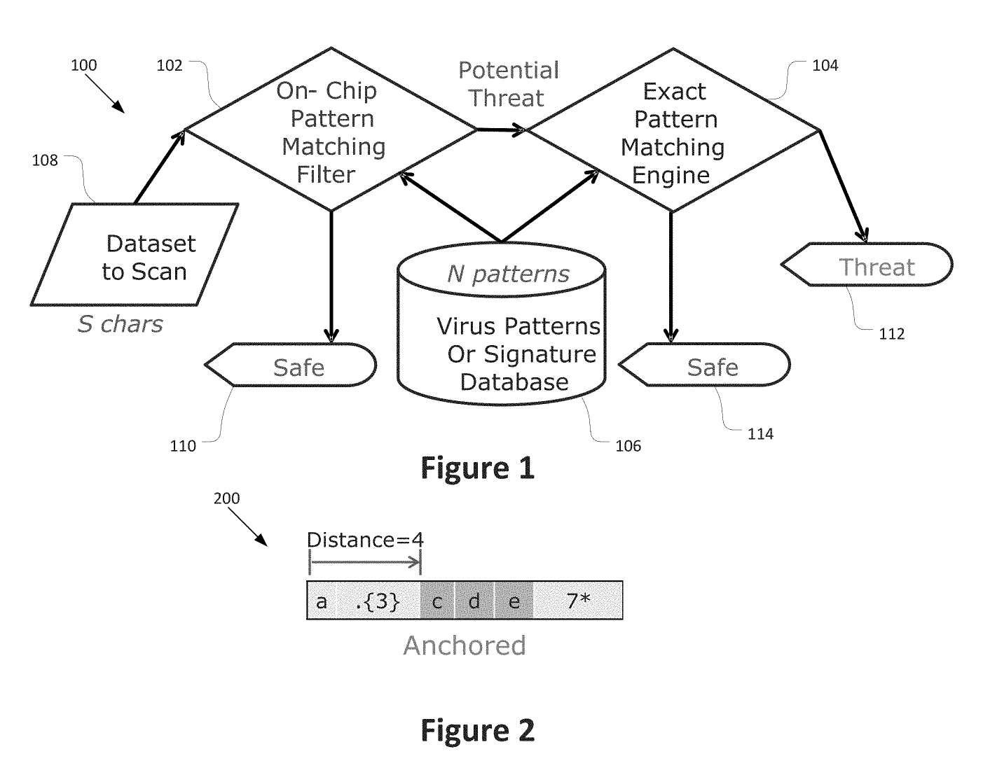

FIG. 1 illustrates a flow diagram of a pattern matching system 100 (“system 100”) in accordance with various embodiments. The system 100 is shown in the context of matching one or more strings of a dataset to one or more reference strings of a database of virus patterns or signatures. However, the pattern matching techniques described herein for system 100 may be used for other types of pattern matching in addition to or instead of for virus detection.

System 100 includes an on-chip pattern matching filter 102 and an exact pattern matching engine 104. The on-chip pattern matching filter 102 may be included on a same die as a processor to enable the processor to offload pattern matching functions to the on-chip pattern matching filter 102. The on-chip pattern matching filter 102 and exact pattern matching engine 104 are both coupled with and have access to a database 106 of virus patterns or signatures. The on-chip pattern matching filter 102 receives a dataset 108 to be scanned. The on-chip pattern matching filter 102 may determine whether any of the patterns or signatures in the database 106 are potential matches with one or more strings of the dataset 108. If the on-chip pattern matching filter 102 determines that no patterns or signatures in the database 106 are potential matches for the dataset 108, then the on-chip pattern matching filter 102 may determine that the dataset 108 is safe (e.g., at 110). If the on-chip pattern matching filter 102 determines that one or more patterns or signatures in the database 106 are potential matches with the dataset 108, the on-chip pattern matching filter 102 may indicate the potential matches to the exact pattern matching engine 104.

In various embodiments, the exact pattern matching engine 104 may receive the indication of the potential matches, and may determine whether the potential matches are exact matches for the dataset 108. If one or more of the potential matches are exact matches for the dataset 108, then the exact pattern matching engine 104 may determine that the dataset 108 is a threat (e.g., at 112). The exact pattern matching engine 104 may send an indication of the threat to the processor and/or otherwise mark the dataset 108 as a threat. If none of the potential matches are determined to be exact matches for the dataset 108, then the exact pattern matching engine 104 may determine that the dataset 108 is safe (e.g., at 114). The exact pattern matching engine 104 may send an indication to the processor that the dataset is safe and/or otherwise mark the dataset 108 as safe.

In various embodiments, the on-chip pattern matching filter 102 may be designed to provide no false negatives (e.g., mark a dataset as safe/no match when there is actually a match). However, the on-chip pattern matching filter 102 may generate some false positives (e.g., mark a dataset as a potential match/threat when there is actually no match/threat). Various embodiments herein provide an on-chip pattern matching filter with improved performance and/or efficiency (e.g., power and/or area efficiency). In some embodiments, the on-chip pattern matching filter may be provided with improved efficiency without significantly reducing the probability of false positives.

FIG. 2 illustrates an anchored regular expression 200 in accordance with various embodiments. An anchored regular expression may include a fixed string of characters at a deterministic position in the string. The fixed string of characters may be referred to as a key. For example, the anchored regular expression 200 includes fixed string (key) “cde” at an anchor distance of 4 from the beginning of the string. An anchored regular expression is distinguished from a floating regular expression, which includes a fixed string of characters at an unknown position within the string.

In various embodiments, the on-chip pattern matching filter described herein may be used for anchored regular expressions and for fixed strings (in which all characters of the string are fixed). A fixed string may also be considered an anchored regular expression with an anchor distance of 0.

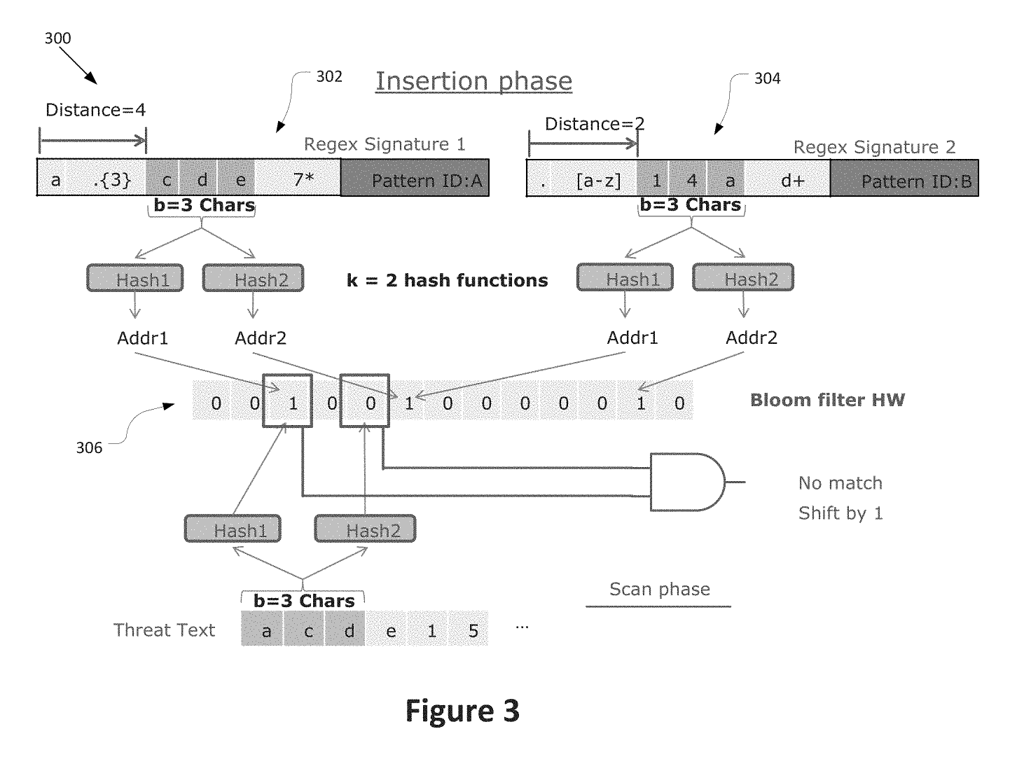

FIG. 3 illustrates a filtering technique 300 that may be performed by the on-chip pattern matching filter 102 in accordance with various embodiments. In some embodiments, the filtering technique 300 may implement a Bloom filter. During an insertion phase, the on-chip pattern matching filter 102 may receive a plurality of signatures that are to be used as reference signatures for the on-chip pattern matching filter. The signatures may include anchored regular expressions, such as anchored regular expressions 302 and 304 shown in FIG. 3. The anchored regular expressions may include a key having a number, b, of fixed characters after an anchor distance. The filtering technique 300 is described herein using a 3-character key (b=3), however keys having other numbers of fixed characters may be used in other embodiments. As shown in FIG. 3, anchored regular expression 302 includes a key having fixed characters cde at an anchor distance of 4, while anchored regular expression 304 includes a key having fixed characters 14a at an anchor distance of 2.

As discussed above, the filtering technique 300 may additionally or alternatively be used for fixed strings. Fixed strings may also be considered anchored regular expressions with an anchor distance of 0.

In accordance with the filtering technique 300, the on-chip pattern matching filter 102 may perform a number, k, of hash functions on the key of each signature to generate respective addresses. The number k may be 1 or more, such as 2 or more. For example, the filtering technique 300 is shown in FIG. 3 using two hash functions, Hash1 and Hash2. In some embodiments, the hash functions may be H3 hash functions, as further described below.

The on-chip pattern matching filter may further include a memory array 306 including a plurality of bits. Prior to the insertion phase, all bits of the memory array 306 may be initialized to logic 0. For each signature that is to be inserted in the filter during the insertion phase, the on-chip pattern matching filter may perform the k hash functions on the b fixed bits to generate respective addresses (e.g., 2 addresses for 2 hash functions) that correspond to individual bits of the memory array 306. The on-chip pattern matching filter may write a logic 1 to the individual bits to which the generated addresses correspond.

During a scan phase of the filtering technique 300, the on-chip pattern matching filter may receive a string that is to be scanned. The on-chip pattern matching filter may perform the k hash functions on the first b (e.g., 3) characters in the string to generate respective addresses. The on-chip pattern matching filter may read the bits of the memory array 306 to which the addresses correspond. If all the bits that are read are logic 1, then the string is identified as a potential match (e.g., potential threat). The string may be passed to an exact pattern matching engine (e.g., the exact pattern matching engine 104) for further processing.

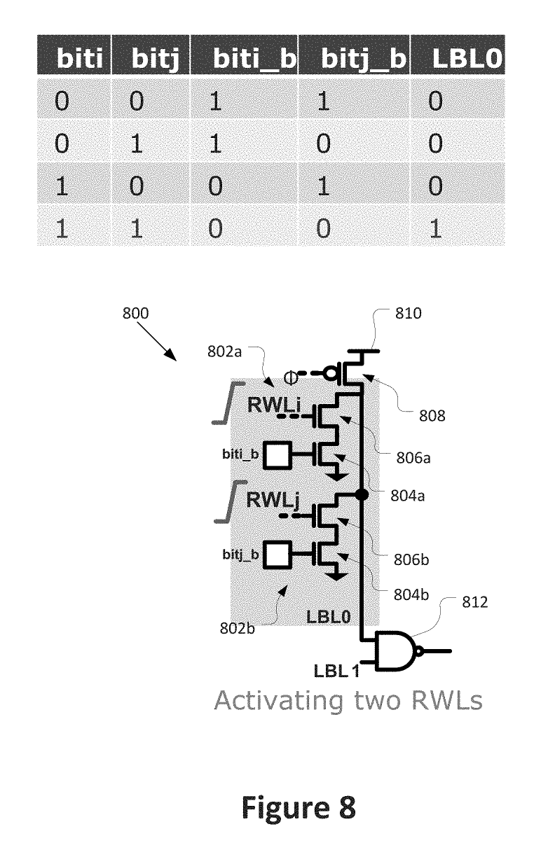

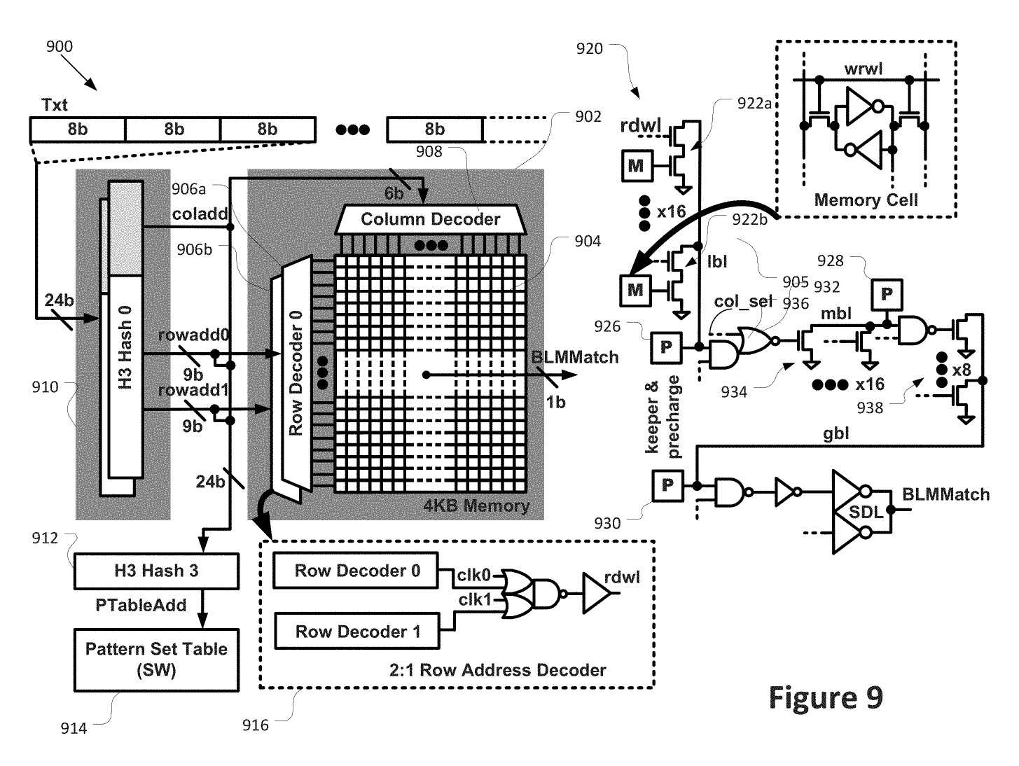

In some embodiments, if two hash functions are used, thereby generating two addresses, an AND function may be used on the two corresponding bits to determine if the string is a potential match. In some embodiments, as discussed further below with respect to FIGS. 8 and 9, a NOR function may be performed on the inverse data from the memory cells to replicate an AND function on the non-inverse data.

If there is no potential match for the first b (e.g., 3) characters in the string, the on-chip pattern matching filter shifts the characters of the string by 1 and repeats the scan. For example, characters 0-2 may be scanned for a potential match, then characters 1-3, then characters 2-4, and so on. If there are no matches for any set of b characters in the string, then the on-chip pattern matching filter may determine that there is no match for the string.

In various embodiments, the hash functions performed on sets of fixed characters from different signatures may generate one or more common addresses. Accordingly, there is potential for false positives. However, there may be no false negatives, and the false positive rate may be lower than for other types of matching filters. Additionally, various techniques are further discussed below to further improve the efficiency (e.g., power and/or area efficiency) of the matching filter. In some embodiments, the efficiency of the matching filter may be improved without significantly increase the probability of false positives.

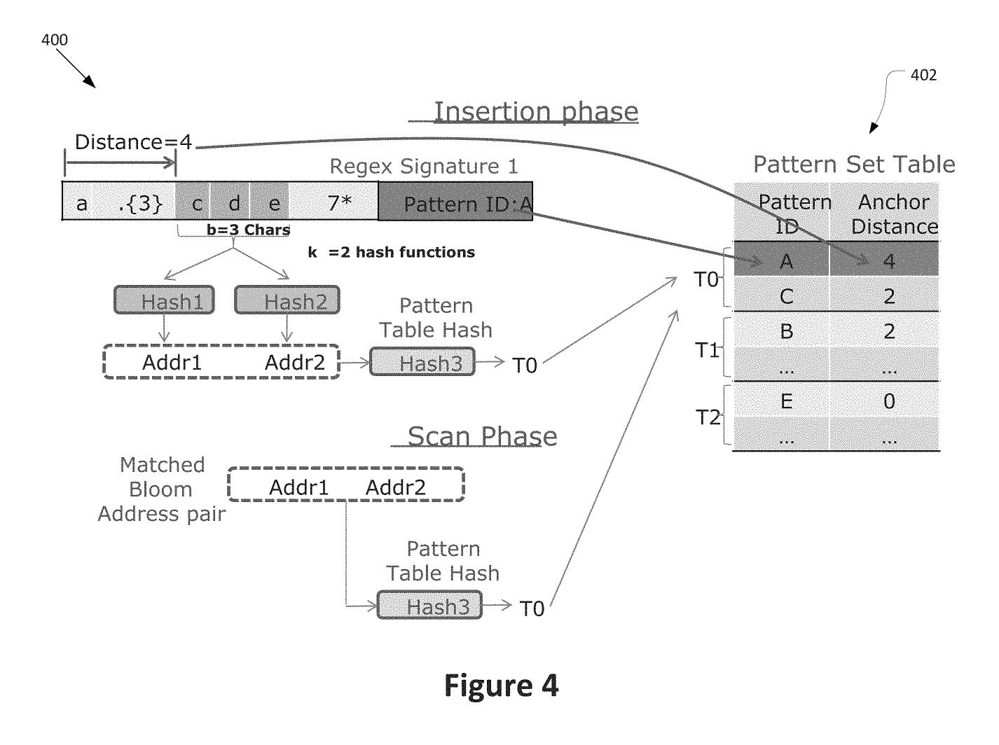

FIG. 4 illustrates a technique 400 for generating and using a pattern set table 402 that may be used in conjunction with the technique 300. The technique 400 may be performed by the on-chip pattern matching filter, such as the on-chip pattern matching filter 102. As discussed above with respect to technique 300, during the insertion phase a plurality of hash functions (e.g., 2 hash functions) may be performed on the key of b fixed characters (e.g., 3 fixed characters) of the anchored regular expression 302 to generate respective addresses (e.g., Addr1 and Addr2). As part of the technique 400, a pattern table hash function (e.g., a third hash function, hash3) may be performed on the addresses. The pattern table hash function may generate an indicator (e.g., address) of a table entry in the pattern set table 402.

The on-chip pattern matching filter may store a pattern identifier of the signature (e.g., anchored regular expression) and may store the pattern identifier in the table entry of the pattern set table 402 indicated by the pattern table hash function. In some embodiments, the on-chip pattern matching filter may also store the anchor distance of the signature in the table entry of the pattern set table 402. In some embodiments, the pattern set table 402 may be implemented in software.

During the scan phase, the on-chip pattern matching filter may identify a set of addresses that indicate a potential match for an associated sample signature, as described above. The on-chip pattern matching filter may pass the sample signature to the exact pattern matching engine. The exact pattern matching engine may perform the pattern table hash function on the set of addresses to generate a corresponding table entry of the pattern set table 402. The exact pattern matching engine may perform the exact match process for the sample signature with reference to the signatures identified in the table entry and the associated anchor distances. Accordingly, the pattern set table 402 may significantly reduce the number of signatures that need to be checked for an exact match for a given set of addresses that indicate a potential match.

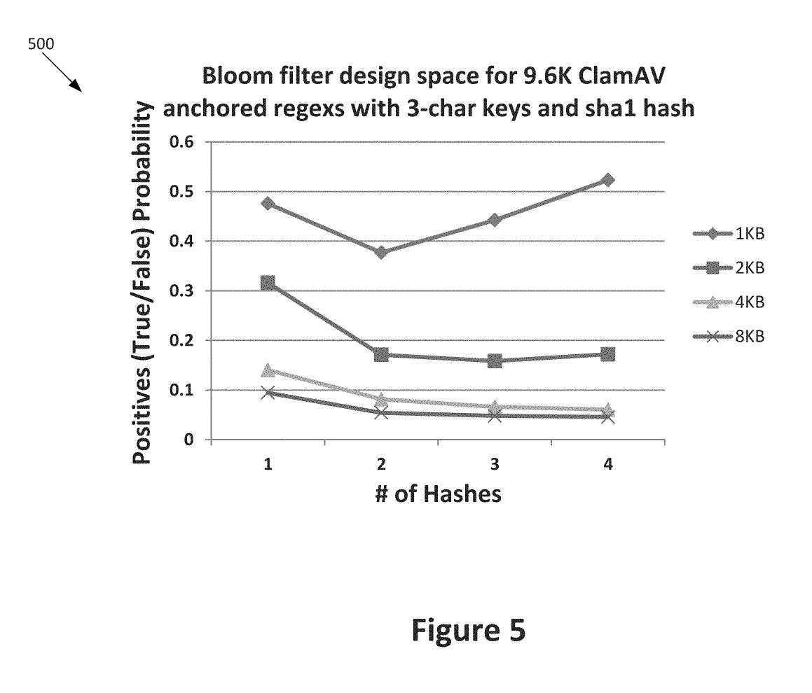

FIG. 5 shows a graph 500 to illustrate design tradeoffs for the on-chip pattern matching engine (e.g., on-chip pattern matching engine 102). The graph 500 shows plots of the probability of a positive match being true or false (lower number corresponds to lower rate of false positives) compared with the number k of hash functions used. The graph 500 shows plots for different sizes of the bloom filter's memory array (e.g., 1 kilobyte (KB), 2 KB, 4 KB, 8 KB), with 9,600 ClamAV anchored regular expressions stored in the bloom filter, each anchored regular expression having a 3-character key (e.g., b=3), and using SHA1 hash functions.

As shown in FIG. 5, the probability of a false positive generally decreases with an increase in size of the memory array, but the impact is relatively small between a 4 KB memory array and an 8 KB memory array. Additionally, using two hash functions significantly reduces the probability of false positives, but increasing the number of hash functions to 3 or 4 hash functions provides only a small reduction or even an increase in the probability of false positives. Accordingly, the size of the memory array and the number of hash functions used to generate corresponding addresses in the memory array may be selected to balance the considerations of providing a low false positive probability while efficiently using power and area of the chip. In some embodiments, the on-chip pattern matching filter may include a 4 KB memory array and use two hash functions to store about 10,000 signatures, and embodiments and techniques herein may be described with reference to such an on-chip pattern matching filter. It will be apparent that other values may be used in other embodiments.

In some embodiments, as discussed above, H3 hash functions may be used to generate the addresses associated with the signature key. Each H3 hash function may have an associated random matrix of 1's and 0's. For example, for a 4 KB bloom filter with a 3-character key, the H3 hash functions may include a 24×15 matrix of bits having randomly assigned values of logic 1 or logic 0. The matrix may have 24 rows since each of the 3 characters may be represented by 8 bits, and may have 15 columns to provide a 15-bit address. To generate the address, an XOR operation may be performed between the matrix and the 3-character (24-bit) key based on the H3 hash function.

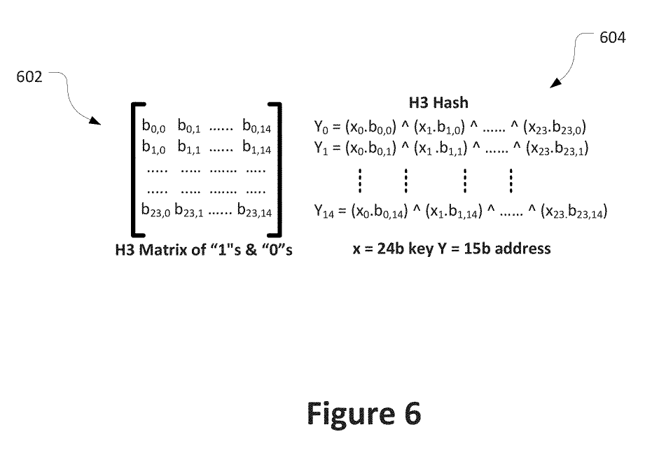

For example, FIG. 6 illustrates an H3 matrix 602 and corresponding hash function 604. The hash function 604 may generate a 15-bit address (Y₀-Y₁₄) from the H3 matrix 602 and a 24-bit key (x₀-x₂₃). The H3 hash function 604 demonstrates a true/false probability similar to a SHA1 hash and passes the Chi squared uniformity test (p value <0.1).

In various embodiments, the H3 matrix 602 may be configured to have a pre-defined number of bits in each column that are set to a logic 1, with the remaining bits of each column set to logic 0. The pre-defined number may be less than one-half the number of bits in each column (e.g., the number of rows), such as one-fourth or less of the number of bits in each column. For example, for the H3 matrix 602 that includes 24 bits per column, the H3 matrix 602 may be configured to have 4 logic 1 bits per column (with 20 logic 0 bits). In some embodiments, the H3 matrix 602 may be configured to have precisely the pre-defined number of logic 1 bits per column. In other embodiments, the H3 matrix 602 may be configured to have no more than the pre-defined number of logic 1 bits per column (e.g., 4 or fewer logic 1 bits).

Configuring the H3 matrix 602 to have a pre-defined number of logic 1 bits in each column may reduce the number of logic gates (e.g., XOR gates) and/or the number of gate stages needed to implement the hash function. Accordingly, the reduced number of logic gates and/or gate stages may reduce the area and/or power requirements of the H3 matrix. However, the pre-defined number may be selected so that the H3 hash function has an acceptable false positive probability.

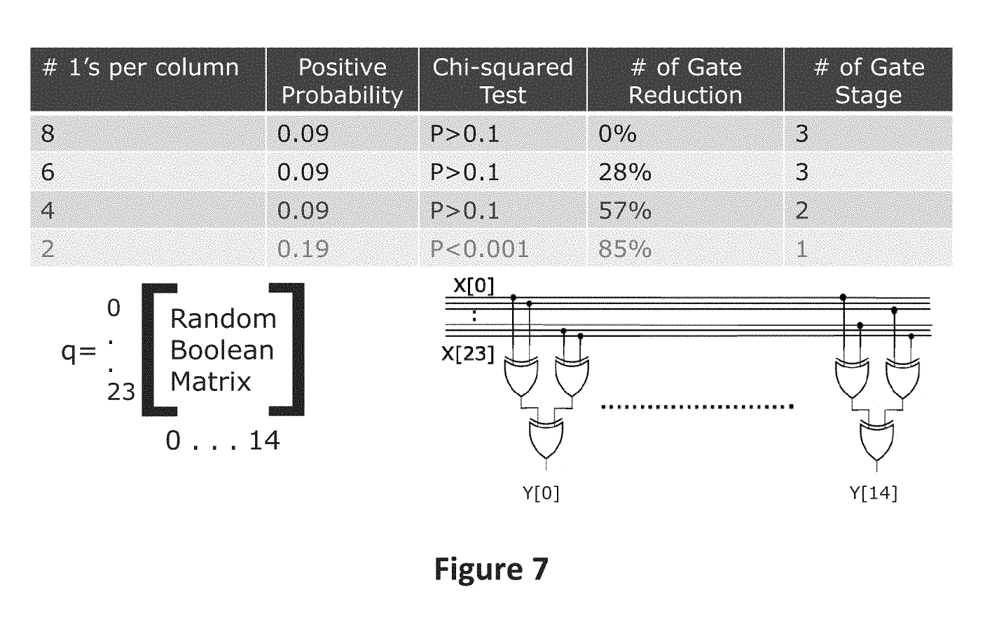

For example, FIG. 7 shows simulation results for the false positive probability, Chi-squared test, reduction in number of gates (with reference to 8 logic 1 bits per column) and the number of gate stages for the H3 matrix having 2, 4, 6, or 8 logic 1 bits per column. As shown, the false positive probability is about 0.09 for the H3 matrix having 4, 6, or 8 logic 1 bits per column, but the H3 matrix with 4 logic 1 bits per column has 57% fewer gates than the H3 matrix with 8 logic 1 bits per column and uses 2 gate stages rather than 3 gate stages. Accordingly, configuring the H3 matrix with 4 logic 1 bits may significantly reduce the area and power requirements of the hash function without significantly affecting the false positive probability.

In various embodiments, the memory array used by the on-chip pattern matching filter may use two read ports and one write port with single bit read access. The two read ports may be used to read the bits corresponding to the respective addresses generated by the two hash functions.

However, in some embodiments, the memory array may use a single read port with two wordlines activated simultaneously to read two different bits. The read port may use the bitline NOR gate in the read port to output a NOR function of the two bits. In order to utilize the bitline NOR gate, the two bits that are read must be from the same column of the memory array. Accordingly, in some embodiments, the addresses generated by the two hash functions may be configured to provide the same column address. For example, the column address generated by the first hash function may be reused for the address generated by the second hash function.

FIG. 8 illustrates a read port 800 with a plurality of read pulldowns 802a-b, in which two read pulldowns may be activated simultaneously, in accordance with various embodiments. The read pulldowns 802a-b may include a transistor 804a-b and transistor 806a-b coupled between ground and a local bitline LBL0. The gate terminal of the transistor 804a-b may be coupled to the respective memory cell, and transistor 806a-b may be coupled to receive a respective wordline signal (e.g., read wordline signals RWLi and RWLj). In various embodiments, the read pulldowns 802a-b may read the inverted data from the respective memory cells. For example, read pulldown 802a may read the value biti_b that is the inverse (bar) of the value biti that is stored by the associated memory cell, and read pulldown 802b may read the value bitj_b that is the inverse (bar) of the value bitj that is stored by the associated memory cell. Although only two read pulldowns 802a-b are shown in FIG. 8, the read port 800 may include a read pulldown 802a-b for each row of the memory array.

A pre-charge transistor 808 may be coupled between the local bitline LBL0 and a supply rail 810. The pre-charge transistor 808 may receive a clock signal (Φ) at its gate terminal. The clock signal may turn on the pre-charge transistor 808 during a first clock phase to pre-charge the local bitline LBL0 to a logic 1. The clock signal may turn off the pre-charge transistor 810 during the second clock phase. The wordlines for the selected pair of rows (e.g., RWLi and RWLj) may be activated during the second clock phase to simultaneously read the inverted data from the two associated memory cells.

Accordingly, during the second clock phase, the local bitline LBL0 may have a logical value as shown in the truth table. As shown, the read pulldowns 802a-b form a NOR gate with inputs biti_b and bitj_b. For example, the local bitline LBL0 may be forced to a logic 0 if either biti_b or bitj_b has a value of logic 1, thereby turning on the associated transistor 802a-b to provide a conductive path between the local bitline LBL0 and ground. The local bitline LBL0 may remain at a value of logic 1 during the second clock phase if both biti_b and bitj_b have a value of logic 0. Accordingly, the local bitline LBL0 may have a value of logic 1 only if both of the non-inverted values biti and bitj have a value of logic 1.

In some embodiments, the local bitline LBL0 may further be coupled to a first input of a NAND gate 812. The second input of the NAND gate 812 may be coupled with a local bitline LBL1. The local bitline LBL1 may be similar to local bitline LBL0, and may be coupled to another set of read pulldowns.

Accordingly, the read port 800 may be used to output a value that corresponds to an AND function between the two selected bits. Therefore, the read port 800 may enable the memory array to use a single read port, rather than have two read ports to separately read the selected bits and an external AND gate to perform the AND function. The use of a single read port 800 may save significant area and power for the memory array. Furthermore, the reuse of the column address for the second hash function may enable the use of the single read port 800 without significantly affecting the probability of false positives.

To demonstrate, a simulation was performed to test the effect of using the same column address for both addresses generated for a signature key. The simulation results are shown in Table 1 below, and illustrate the effect on the false positive probability for two 15-bit addresses associated with different hash functions when 0, 4, 6, or 8 bits of the addresses are forced to be the same.

TABLE 1

| Number of same bits in two | |
|---|---|
| 15-bit addresses | False positive probability |
| 0 | 0.09 |
| 4 | 0.09 |
| 6 | 0.09 |
| 8 | 0.19 |

As shown in Table 1, up to 6 bits of the two 15-bit addresses may be the same without significantly affecting the false positive probability. Accordingly, in some embodiments, the on-chip pattern matching filter may use a memory array with a 6-bit column address and a 9-bit row address.

For example, FIG. 9 shows a pattern matching filter 900 in accordance with various embodiments. Pattern matching filter 900 may be an on-chip pattern matching filter. For example, the pattern matching filter 900 may correspond to the on-chip pattern matching filter 102.

The pattern matching filter 900 may include a memory 902 having a memory array 904 of memory cells (e.g., memory cell 905), a pair of row decoders 906a-b, and a column decoder 908. In one example, the memory array 904 may be a 4 KB memory array divided into four banks of 256×32 bits. A global predecoder may be disposed in the middle of the memory array 904 and shared across the memory banks. The global predecoder may decode one or more of the most significant bits (MSBs), e.g., 2 bits, of the addresses to determine which bank of the memory array 904 is indicated by the addresses.

The pattern matching filter 900 may further include a hash function generator 910 to perform one or more (e.g., two) hash functions. The hash function generators 910a-b may receive an input bit string that corresponds to a key of a signature (e.g., a 24-bit string that corresponds to a 3-character key). The hash function generator 910 may perform respective hash functions (e.g., H3 hash functions) on the input bit string to generate respective addresses. The addresses may include a row address and a column address. As discussed above, the column address for both addresses may be the same. Accordingly, the row addresses generated by the hash function generator 910 (e.g., rowadd0 and rowadd1) may be passed to the respective row decoders 906a-b, and the column address generated by the first hash function (e.g., coladd) may be passed to the column decoder 908. The column address generated by the second hash function may not be used.

The pattern matching filter 900 may further include a pattern table hash function generator 912 that receives the address signals generated by the hash function generators 910a-b and performs a pattern table hash function between the address signals to generate a pattern table address. The pattern table hash function generator 912 may pass the pattern table address to a pattern set table 914. The pattern set table 914 may be similar to the pattern set table 402 of FIG. 4.

In various embodiments, the row decoders 906a-b may activate respective read/write word lines of the memory array 904 based on the respective row addresses. The column decoder 908 may activate a bitline of the memory array 904 based on the input column address. The pattern matching filter 900 may include a 2:1 row address decoder 916 to activate two read wordlines simultaneously based on the address signals. The 2:1 row address decoder 916 may activate read wordlines by gating the wordline and clock signals.

The pattern matching filter 900 may further include a read circuit 920 that enables single-bit read from the memory array 904. The read circuit 920 may include a plurality of read pulldowns 922a-b coupled between respective memory cells 905 and a local bitline (lbl). The read pulldowns 922a-b may correspond to the read pulldowns 802a-b. In one embodiment, the read circuit 920 may include 16 read pulldowns 922a-b per local bitline to enable single bit access across an associated 16-bit word.

The read circuit 920 may further include keeper and pre-charge logic 926, 928, and 930. The keeper and pre-charge logic 926 may include the pre-charge transistor 808.

The read circuit 920 may further include 2-way static AND-OR-Invert (AOI) merge logic 932 with embedded column select functionality. The output of the AOI merge logic 932 is passed to a transistor stack 934 that includes a plurality of pull-down transistors (e.g., n-type metal-oxide-semiconductor (NMOS) transistors) coupled to a mid-level bitline (mbl) to enable single-bit access across the 16-bit word. Only one pull-down transistor of the transistor stack 934 may be activated via the decoded column select signal (col_sel) that controls the gate of the AOI merge logic 932.

The mid-level bitline mbl may be coupled to a 2-way static NAND merge logic 936. An output of the NAND merge logic 936 may be coupled to a transistor stack 938 that includes a plurality of pull-down transistors coupled to a global bitline (gbl) to drive a signal on the global bitline. The global bit line gbl may be coupled to a 2:1 multiplexed set dominant latch SDL to generate a single bit output BLMMatch. The signal BLMMatch may indicate whether the two bits read from the memory array 902 indicate a potential match for the associated signature. The bit-wise read provided by the read circuit 920 may save significant power compared with a register file implementation. For example, by one estimation, the read circuit 920 may save more than 41% of the read power of a register file implementation.

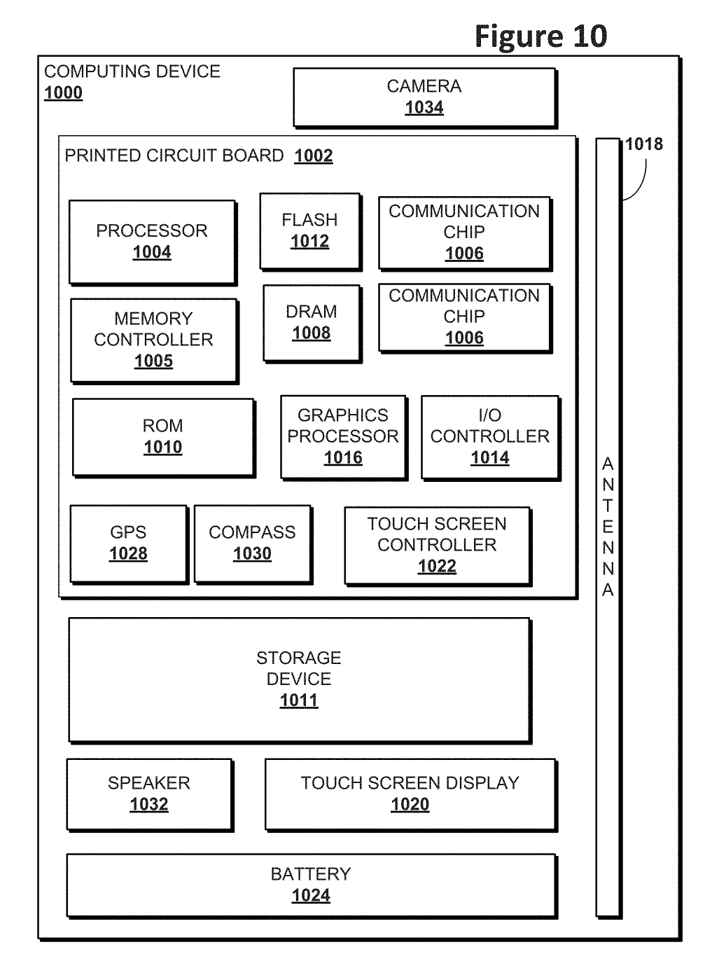

FIG. 10 illustrates an example computing device 1000 that may employ the apparatuses and/or methods described herein (e.g., system 100, filtering technique 300, technique 400, read port 800, and/or pattern matching filter 900), in accordance with various embodiments. As shown, computing device 1000 may include a number of components, such as one or more processor(s) 1004 (one shown) and at least one communication chip 1006. In various embodiments, the one or more processor(s) 1004 each may include one or more processor cores. In various embodiments, the at least one communication chip 1006 may be physically and electrically coupled to the one or more processor(s) 1004. In further implementations, the communication chip 1006 may be part of the one or more processor(s) 1004. In various embodiments, computing device 1000 may include printed circuit board (PCB) 1002. For these embodiments, the one or more processor(s) 1004 and communication chip 1006 may be disposed thereon. In alternate embodiments, the various components may be coupled without the employment of PCB 1002.

Depending on its applications, computing device 1000 may include other components that may or may not be physically and electrically coupled to the PCB 1002. These other components include, but are not limited to, memory controller 1005, volatile memory (e.g., dynamic random access memory (DRAM) 1008), non-volatile memory such as read only memory (ROM) 1010, flash memory 1012, storage device 1011 (e.g., a hard-disk drive (HDD)), an I/O controller 1014, a digital signal processor (not shown), a crypto processor (not shown), a graphics processor 1016, one or more antenna 1018, a display (not shown), a touch screen display 1020, a touch screen controller 1022, a battery 1024, an audio codec (not shown), a video codec (not shown), a global positioning system (GPS) device 1028, a compass 1030, an accelerometer (not shown), a gyroscope (not shown), a speaker 1032, a camera 1034, and a mass storage device (such as hard disk drive, a solid state drive, compact disk (CD), digital versatile disk (DVD)) (not shown), and so forth. In various embodiments, the processor 1004 may be integrated on the same die with other components to form a System on Chip (SoC).

In some embodiments, the one or more processor(s) 1004, flash memory 1012, and/or storage device 1011 may include associated firmware (not shown) storing programming instructions configured to enable computing device 1000, in response to execution of the programming instructions by one or more processor(s) 1004, to practice all or selected aspects of the methods described herein. In various embodiments, these aspects may additionally or alternatively be implemented using hardware separate from the one or more processor(s) 1004, flash memory 1012, or storage device 1011.

In various embodiments, one or more components of the computing device 1000 may include the system 100, read port 800, and/or pattern matching filter 900 and/or practice techniques 300 and/or 400 described herein. For example, the processor 1004 may include a pattern matching circuit that may include system 100, read port 800, and/or pattern matching filter 900 and/or practice techniques 300 and/or 400.

The communication chips 1006 may enable wired and/or wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1006 may implement any of a number of wireless standards or protocols, including but not limited to IEEE 702.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computing device 1000 may include a plurality of communication chips 1006. For instance, a first communication chip 1006 may be dedicated to shorter range wireless communications such as Wi-Fi and Bluetooth, and a second communication chip 1006 may be dedicated to longer range wireless communications such as GPS, EDGE, GPRS, CDMA, WiMAX, LTE, Ev-DO, and others.

In various implementations, the computing device 1000 may be a laptop, a netbook, a notebook, an ultrabook, a smartphone, a computing tablet, a personal digital assistant (PDA), an ultra-mobile PC, a mobile phone, a desktop computer, a server, a printer, a scanner, a monitor, a set-top box, an entertainment control unit (e.g., a gaming console or automotive entertainment unit), a digital camera, an appliance, a portable music player, or a digital video recorder. In further implementations, the computing device 1000 may be any other electronic device that processes data.

Some non-limiting Examples of various embodiments are described below.

Example 1 is a pattern matching circuit comprising: a memory array to store a plurality of bits, wherein the memory array is to implement a pattern matching filter for a plurality of reference strings; and pattern matching circuitry coupled to the memory array. The pattern matching circuitry is to: receive a string; perform a plurality of hash functions on a pre-determined number of characters of the string to generate respective addresses that correspond to respective bits of the memory array, wherein the plurality of hash functions use respective hash matrixes, and wherein the individual hash matrixes include a pre-determined number of logic 1 bits per column; read the bits of the memory array associated with the generated addresses to determine whether the string is a potential match with one or more of the reference strings.

Example 2 is the circuit of Example 1, wherein the plurality of hash functions are H3 hash functions.

Example 3 is the circuit of Example 2, wherein the pre-determined number of logic 1 bits per column is one-fourth or less of a number of rows of the hash matrix.

Example 4 is the circuit of Example 3, wherein the individual hash matrixes include 24 rows and 4 logic 1 bits or less per column.

Example 5 is the circuit of any one of Examples 1 to 4, wherein the generated addresses include a first address and a second address, wherein the first address includes a column address generated by the associated hash function, and wherein the pattern matching circuitry is to reuse the column address of the first address for a column address of the second address.

Example 6 is the circuit of Example 5, wherein the pattern matching circuitry includes a read circuit to activate two read wordlines simultaneously on a same read port to output a value corresponding to an AND function of the bits corresponding to the first and second addresses.

Example 7 is the circuit of Example 1, wherein the reference strings are fixed strings or anchored regular expressions.

Example 8 is the circuit of Example 1, wherein the pattern matching circuitry is further to perform a pattern table hash function between the addresses generated by the plurality of hash functions to generate a pattern table address that corresponds to an entry of a pattern set table.

Example 9 is the circuit of Example 8, further comprising the pattern set table, wherein the entry of the pattern set table includes a pattern identifier and an anchor distance for one or more of the reference signatures that are associated with the addresses generated by the plurality of hash functions.

Example 10 is the circuit of Example 1, wherein the plurality of hash functions is two hash functions and the pre-determined number of characters is three characters.

Example 11 is a pattern matching circuit comprising: a memory array to store a plurality of bits, wherein the memory array is to implement a pattern matching filter for a plurality of reference strings; and pattern matching filter logic coupled to the memory array. The pattern matching circuitry is to: receive a string; generate first and second addresses using first and second hash functions, wherein the first and second addresses are configured to correspond to bits of the memory array in a same column; read the bits of the memory array associated with the first and second addresses to determine whether the string is a potential match with one of the reference strings.

Example 12 is the circuit of Example 11, wherein the first and second hash functions use respective first and second hash matrixes having a pre-determined number of logic 1 bits per column.

Example 13 is the circuit of Example 12, wherein the first and second hash matrixes include 24 rows and 4 logic 1 bits per column.

Example 14 is the circuit of any one of Examples 11 to 13, wherein the pattern matching filter logic, to read the bits of the memory array associated with the generated addresses, is to activate two read wordlines simultaneously on a same read port to output a value corresponding to a NOR function of the bits corresponding to the first and second addresses.

Example 15 is the circuit of Example 11, wherein the reference strings are fixed strings or anchored regular expressions.

Example 16 is the circuit of Example 11, wherein the pattern matching filter logic is further to perform a pattern table hash function between the addresses generated by the plurality of hash functions to generate a pattern table address that corresponds to an entry of a pattern set table, wherein the entry of the pattern set table includes information associated with one or more of the reference signatures that are associated with the addresses generated by the plurality of hash functions.

Example 17 is the circuit of Example 11, wherein the plurality of hash functions is two hash functions and the pre-determined number of characters is three characters.

Example 18 is a computing system comprising: a processor; and a pattern matching filter coupled to the processor. The pattern matching filter includes: a memory array having a plurality of memory cells, wherein the memory array is to implement a pattern matching filter for a plurality of reference strings; a read circuit coupled to the memory array and the processor, wherein the read circuit includes a plurality of read pulldowns coupled to respective memory cells of the memory array and coupled to a same local bitline associated with a column of the memory array, the individual read pulldowns to be activated by respective wordlines; and first and second row decoders to generate wordline signals to simultaneously activate two of the read pulldowns to generate an output signal that indicates whether an input string is a potential match for one or more of the reference strings.

Example 19 is the system of Example 18, wherein the read pulldowns are to read an inverted version of bits stored by the associated memory cells.

Example 20 is the system of Example 18, wherein the pattern matching filter further includes a single column decoder to activate the column of the memory array.

Example 21 is the system of Example 20, wherein the pattern matching filter further includes a hash function generator to perform two hash functions to generate two row addresses that are passed to the respective first and second row decoders to cause the first and second row decoders to generate the wordline signals and a column address that is passed to the column decoder to cause the column decoder to activate the column.

Example 22 is the system of any one of Examples 18 to 21, further comprising a network interface and a display coupled to the processor.

Example 23 is a pattern matching apparatus comprising: means to receive a string of characters; means to perform a plurality of hash functions on a pre-determined number of the characters of the string to generate respective addresses that correspond to respective bits of a memory array, wherein the plurality of hash functions use respective hash matrixes, and wherein the individual hash matrixes include a pre-determined number of logic 1 bits per column; means to read the bits of the memory array associated with the generated addresses to determine whether the string is a potential match with one or more of a plurality of reference strings.

Example 24 is the apparatus of Example 23, wherein the pre-determined number of logic 1 bits per column is one-fourth or less of a number of bits in each column of the hash matrix.

Example 25 is the apparatus of Example 23 or Example 24, further comprising means to provide the first and second addresses with a same column address.

Although certain embodiments have been illustrated and described herein for purposes of description, this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements, and do not indicate or imply a required or limited number of such elements, nor do they indicate a particular position or order of such elements unless otherwise specifically stated.

What is claimed is:

1. A circuit comprising:
a memory array to store a plurality of bits, wherein the memory array is to implement a pattern matching filter for a plurality of reference strings; and
pattern matching circuitry coupled to the memory array, the pattern matching circuitry to:
receive a string;
perform a plurality of hash functions on a pre-determined number of characters of the string to generate respective addresses that correspond to respective bits of the memory array, wherein the plurality of hash functions use respective hash matrixes, and wherein the individual hash matrixes include a pre-determined number of logic 1 bits per column; and
read the bits of the memory array associated with the generated addresses to determine whether the string is a potential match with one or more of the reference strings.

2. The circuit of claim 1, wherein the plurality of hash functions are H3 hash functions.

3. The circuit of claim 2, wherein the pre-determined number of logic 1 bits per column is one-fourth or less of a number of rows of the hash matrix.

4. The circuit of claim 3, wherein the individual hash matrixes include 24 rows and 4 logic 1 bits or less per column.

5. The circuit of claim 1, wherein the generated addresses include a first address and a second address, wherein the first address includes a column address generated by the associated hash function, and wherein the pattern matching circuitry is to reuse the column address of the first address for a column address of the second address.

6. The circuit of claim 5, wherein the pattern matching circuitry includes a read circuit to activate two read wordlines simultaneously on a same read port to output a value corresponding to an AND function of the bits corresponding to the first and second addresses.

7. The circuit of claim 1, wherein the reference strings are fixed strings or anchored regular expressions.

8. The circuit of claim 1, wherein the pattern matching circuitry is further to perform a pattern table hash function between the addresses generated by the plurality of hash functions to generate a pattern table address that corresponds to an entry of a pattern set table.

9. The circuit of claim 8, further comprising the pattern set table, wherein the entry of the pattern set table includes a pattern identifier and an anchor distance for one or more of the reference signatures that are associated with the addresses generated by the plurality of hash functions.

10. The circuit of claim 1, wherein the plurality of hash functions is two hash functions and the pre-determined number of characters is three characters.

11. A pattern matching circuit comprising:
a memory array to store a plurality of bits, wherein the memory array is to implement a pattern matching filter for a plurality of reference strings; and
pattern matching filter logic coupled to the memory array, the pattern matching circuitry to:
receive a string;
generate first and second addresses using first and second hash functions, wherein the first and second addresses are configured to correspond to bits of the memory array in a same column; and
read the bits of the memory array associated with the first and second addresses to determine whether the string is a potential match with one of the reference strings.

12. The circuit of claim 11, wherein the first and second hash functions use respective first and second hash matrixes having a pre-determined number of logic 1 bits per column.

13. The circuit of claim 12, wherein the first and second hash matrixes include 24 rows and 4 logic 1 bits per column.

14. The circuit of claim 11, wherein the pattern matching filter logic, to read the bits of the memory array associated with the generated addresses, is to activate two read wordlines simultaneously on a same read port to output a value corresponding to a NOR function of the bits corresponding to the first and second addresses.

15. The circuit of claim 11, wherein the reference strings are fixed strings or anchored regular expressions.

16. The circuit of claim 11, wherein the pattern matching filter logic is further to perform a pattern table hash function between the addresses generated by the plurality of hash functions to generate a pattern table address that corresponds to an entry of a pattern set table, wherein the entry of the pattern set table includes information associated with one or more of the reference signatures that are associated with the addresses generated by the plurality of hash functions.

17. The circuit of claim 11, wherein the plurality of hash functions is two hash functions and the pre-determined number of characters is three characters.

18. A system comprising:
a processor; and
a pattern matching filter coupled to the processor, the pattern matching filter including:
a memory array having a plurality of memory cells, wherein the memory array is to implement a pattern matching filter for a plurality of reference strings;
a read circuit coupled to the memory array and the processor, wherein the read circuit includes a plurality of read pulldowns coupled to respective memory cells of the memory array and coupled to a same local bitline associated with a column of the memory array, the individual read pulldowns to be activated by respective wordlines; and
first and second row decoders to generate wordline signals to simultaneously activate two of the read pulldowns to generate an output signal that indicates whether an input string is a potential match for one or more of the reference strings.

19. The system of claim 18, wherein the read pulldowns are to read an inverted version of bits stored by the associated memory cells.

20. The system of claim 18, wherein the pattern matching filter further includes a single column decoder to activate the column of the memory array.

21. The system of claim 20, wherein the pattern matching filter further includes a hash function generator to perform two hash functions to generate two row addresses that are passed to the respective first and second row decoders to cause the first and second row decoders to generate the wordline signals and a column address that is passed to the column decoder to cause the column decoder to activate the column.

22. The system of claim 18, further comprising a network interface and a display coupled to the processor.

23. A pattern matching apparatus comprising:
means to receive a string of characters;
means to perform a plurality of hash functions on a pre-determined number of the characters of the string to generate respective addresses that correspond to respective bits of a memory array, wherein the plurality of hash functions use respective hash matrixes, and wherein the individual hash matrixes include a pre-determined number of logic 1 bits per column;
means to read the bits of the memory array associated with the generated addresses to determine whether the string is a potential match with one or more of a plurality of reference strings.

24. The apparatus of claim 23, wherein the pre-determined number of logic 1 bits per column is one-fourth or less of a number of bits in each column of the hash matrix.

25. The apparatus of claim 23, further comprising means to provide the first and second addresses with a same column address.
